(19) United States
(12) Patent Application Publication
(10) Pub. No.: US 2012/0189530 A1
(43) Pub. Date: Jul. 26, 2012

(54) System And Process For Producing Hydrogen And A Carbon Nanotube Product

(75) Inventors: Roger W. Marmaro, Chandler, AZ (US); Max A. Schmid, Aurora, CO (US); Justin Fulton, Fort Collins, CO (US); Gary Lee Anderson, Littleton, CO (US); Gregory Solomon, Cottesloe (AU)

(73) Assignee: Eden Energy Ltd., Perth (AU)

(21) Appl. No.: 13/353,894

(22) Filed: Jan. 19, 2012

Related U.S. Application Data
(60) Provisional application No. 61/434,722, filed on Jan. 20, 2011.

(51) Int. Cl. C01B 31/02; C10J 3/00; B01J 19/18; D01F 9/127; B82B 3/00

(52) U.S. Cl. 423/447.3; 422/187; 423/445 R; 48/197 R; 977/896; 977/843

(57) ABSTRACT

A system for producing hydrogen and a carbon nanoproduct includes a hydrocarbon feed gas supply configured to supply a hydrocarbon feed gas at a selected flow rate, a reactor having a hollow reactor cylinder with an enclosed inlet adapted to continuously receive the hydrocarbon feed gas, a reaction chamber in fluid communication with the inlet, and an enclosed outlet in fluid communication with the reaction chamber adapted to discharge a product gas comprised of hydrogen and unreacted hydrocarbon feed gas, along with the carbon nanoproduct. The system also includes a catalyst transport system adapted to move a selected amount of a metal catalyst through the reaction chamber at a rate dependent on the flow rate of the hydrocarbon feed gas to form the product gas. The system also includes a carbon separator adapted to separate the carbon product from the product gas and from the metal catalyst.

### CROSS REFERENCE TO RELATED APPLICATIONS

This application claims priority from U.S. provisional application No. 61/434,722 filed Jan. 20, 2011.

### FIELD

This disclosure relates generally to the production of hydrogen and carbon, and more particularly to a novel continuous system and process for producing hydrogen and carbon nanoproducts, such as carbon nanofibers and carbon nanotubes.

### BACKGROUND

Processes and systems are known in the art for producing hydrogen and carbon products by the decomposition of hydrocarbons, such as methane and natural gas, in the presence of metal alloy catalysts. For example, U.S. Pat. No. 8,075,869 B2, entitled “Method And System For Producing A Hydrogen Enriched Fuel Using Microwave Assisted Methane Decomposition On Catalyst”, U.S. Pat. No. 8,021,448 B2, entitled “Method And System For Producing A Hydrogen Enriched Fuel Using Microwave Assisted Methane Plasma Decomposition On Catalyst”, and U.S. Pat. No. 8,092,778 B2, entitled “Method For Producing A Hydrogen Enriched Fuel And Carbon Nanotubes Using Microwave Assisted Methane Decomposition On Catalyst”, all of which are incorporated herein by reference, disclose processes and systems for producing hydrogen and carbon.

In general these prior art processes are non-continuous batch processes performed in the laboratory that have not been adapted to commercial production. It would be advantageous to be able to produce both hydrogen and carbon nanoproducts in commercial quantities. In addition, it would be advantageous to produce hydrogen, in the form of a hydrogen enriched fuel or pure hydrogen, along with a carbon nanoproduct having different commercial applications. The high cost of producing the hydrogen could then be offset by the sale of the carbon nanoproduct. The present disclosure is directed to a novel continuous system and process for producing hydrogen and carbon nanostructures in commercial quantities.

### SUMMARY

A system for producing hydrogen and a carbon nanoproduct includes a hydrocarbon feed gas supply and a reactor. The hydrocarbon feed gas supply provides a hydrocarbon feed gas such as pure methane, natural gas, a mixture of methane and natural gas, or a higher order hydrocarbon, such as ethylene or propane and mixtures thereof, at a selected flow rate. The reactor includes a hollow reactor cylinder having an enclosed inlet adapted to continuously receive the hydrocarbon feed gas and an inert gas, a reaction chamber, and an enclosed outlet adapted to discharge a product gas comprised of hydrogen and unreacted hydrocarbon feed gas, along with the carbon nanoproduct. The reaction chamber can be heated to a selected temperature using an energy source, such as thermal combustion or electricity.

The system also includes a catalyst feed in fluid communication with the inlet of the reactor cylinder, and a catalyst transport system adapted to move a metal catalyst through the reaction chamber in contact with the hydrocarbon feed gas. The catalyst transport system is adapted to provide a selected amount of catalyst that is matched to the flow rate of the hydrocarbon feed gas to provide optimal reaction kinetics in the reaction chamber for producing the carbon nanoproduct. The catalyst transport system can be in the form of a chain conveyor system, a rotating auger system, a high velocity pneumatic system or a plunger system. As the metal catalyst moves through the heated reaction chamber, the hydrocarbon feed gas breaks down into its major constituent atoms, namely carbon and hydrogen. Depending on the composition of the metal catalyst, the carbon atoms react with active sites on the metal catalyst to form the carbon nanoproduct. This carbon nanoproduct combined with the metal catalyst is physically pushed from the inlet through the reaction chamber to the outlet of the reactor cylinder. The carbon nanoproduct includes carbon nanostructures having desired physical, electrical and thermal characteristics controlled by selection of the catalyst and control of the process parameters. The system also includes a carbon separator adapted to separate the carbon nanoproduct from the product gas and from the metal catalyst via gravity or cyclonic separation, and a container located proximate to the outlet end of the reactor cylinder adapted to collect the carbon nanoproduct.

A portion of the product gas can be used as a fuel for heating the reaction chamber when a combustion heated reactor is used. In addition, the product gas can be further processed via pressure swing adsorption or a molecular sieve to produce a pure hydrogen gas product. Alternately, when pure methane or natural gas is used as the hydrocarbon feed gas, the product gas can be configured for use as an alternative fuel having selected percentages of hydrogen and hydrocarbon. For example, the alternative fuel can comprise about 20% to 30% hydrogen by volume and about 70% to 80% methane by volume.

A process for producing hydrogen and a carbon nanoproduct includes the steps of: providing a reactor having a reaction chamber in fluid communication with a hydrocarbon feed gas supply, and providing a catalyst transport system adapted to move a selected amount of metal catalyst through the reaction chamber in contact with a hydrocarbon feed gas at a selected flow rate. The process also includes the step of moving the hydrocarbon feed gas and the metal catalyst through the reaction chamber while using the catalyst transport system to provide a selected mass ratio of the catalyst to the hydrogen feed gas. During the moving step the amount of catalyst is in effect matched to the flow rate of the hydrocarbon feed gas to provide optimal reaction kinetics. The process also includes the step of heating the hydrocarbon feed gas and the metal catalyst, reacting the hydrocarbon feed gas to form a product gas comprised of hydrogen and unreacted hydrocarbon gas and the carbon nanoproduct, and separating the carbon nanoproduct from the product gas and the metal catalyst. The process can also include the step of further processing the product gas into pure hydrogen or alternately using the product gas as an alternative fuel comprised of methane and hydrogen in selected proportions.

### BRIEF DESCRIPTION OF THE DRAWINGS

FIG. 1 is a schematic of a system for producing hydrogen and a carbon nanoproduct;

FIG. 2A is a first TEM (transmission electron microscopy) image of a carbon nanoproduct produced by the system in the form of carbon nanotubes;

FIG. 2B is a second TEM (transmission electron microscopy) image of a carbon nanoproduct produced by the system in the form of carbon nanotubes;

FIG. 3 is a graph illustrating a raman spectra of a carbon nanoproduct produced by the system in the form of carbon nanotubes;

FIG. 4A is a first TEM (transmission electron microscopy) image of a carbon nanoproduct produced by the system in the form of carbon nanofibers;

FIG. 4B is a second TEM (transmission electron microscopy) image of a carbon nanoproduct produced by the system in the form of carbon nanofibers; and

FIG. 5 is a graph illustrating a raman spectra of a carbon nanoproduct produced by the system in the form of carbon nanofibers.

### DETAILED DESCRIPTION

As used herein “carbon nanoproduct” means a product comprising allotropes of carbon having nanostructures with dimensions on the order of nanometers (nm). “Nanofibers” means nanostructures comprised of fibers having diameters less than 1000 nm. “Nanotubes” means nanostructures comprised of cylindrical tubes having a high length to diameter ratio. Nanotubes can be categorized as single-walled nanotubes (SWNTs) or multi-walled nanotubes (MWNTs).

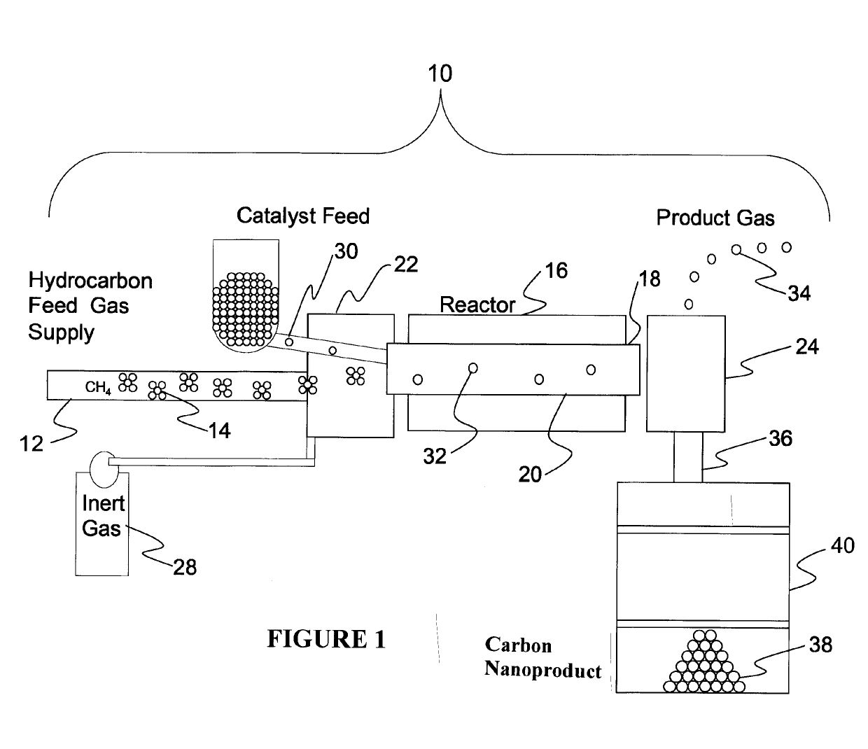

Referring to FIG. 1, a system 10 for producing hydrogen and a carbon nanoproduct 38 is illustrated schematically. The system 10 includes a hydrocarbon feed gas supply 12 configured to supply a hydrocarbon feed gas 14. The hydrocarbon feed gas 14 can comprise pure methane or natural gas obtained from a “fossil fuel” deposit. Natural gas is typically about 90% methane, along with small amounts of ethane, propane, higher hydrocarbons, and “inerts” like carbon dioxide or nitrogen. Alternately, the hydrocarbon feed gas 14 can comprise a higher order hydrocarbon such as ethylene or propane. In addition, the hydrocarbon feed gas supply 12 can comprise a tank (or a pipeline) configured to supply the hydrocarbon feed gas 14 at a selected temperature, pressure, and flow rate. By way of example the temperature of the hydrocarbon feed gas 14 can be from 600 to 900° C., the pressure can be from 0.0123 to 0.0615 atmospheres and the flow rate can be from 0.05 to 3.0 liter/minute per gram of catalyst.

The system 10 also includes a reactor 16 comprising a hollow reactor cylinder 18 having an enclosed inlet 22 adapted to continuously receive the hydrocarbon feed gas 14, a reaction chamber 20 in fluid communication with the inlet 22, and an enclosed outlet 24 in fluid communication with the reaction chamber 20 adapted to discharge a product gas 34 comprised of hydrogen and unreacted hydrocarbon feed gas, along with the carbon nanoproduct 38. For performing the process, the reaction chamber 20 can be heated by thermal combustion or electricity to a temperature of from 600 to 900° C. In addition, the inlet 22 and the reaction chamber 20 can be in fluid communication with an inert gas supply 28.

The system 10 also includes a catalyst transport system 30 adapted to move a metal catalyst 32 through the reaction chamber 20 in contact with the hydrocarbon feed gas 14 to form the product gas 34. The catalyst transport system 30 can be in the form of a chain conveyor system, a rotating auger system, a high velocity pneumatic system or a plunger system. In any case, the catalyst transport system 30 is adapted to move a selected amount of the metal catalyst 32 through the reaction chamber 20 at a rate dependent on the flow rate of the hydrocarbon feed gas 14. For example, with the flow rate of the hydrocarbon feed gas between 0.05 and 3.0 liters/minute, the selected amount of the catalyst can be about one gram/minute.

The metal catalyst 32 can be provided in the form of particles. A preferred metal for the catalyst comprises Ni, or an alloy containing Ni. For example, the metal can comprise NiAl, or Ni alloyed with Cu, Pd, Fe, Co, or an oxide such as MgO, ZnO, Mo₂O₃ or SiO₂. However, rather than Ni or an alloy thereof, the metal catalyst 32 can comprise another metal, such as a metal selected from group VIII of the periodic table including Fe, Co, Ru, Pd and Pt.

The system 10 also includes a carbon separator 36 adapted to separate the carbon nanoproduct 38 from the product gas 34 and from the metal catalyst 32 via gravity or cyclonic separation. The system 10 can also include a container 40 located proximate to the outlet 24 adapted to collect the carbon nanoproduct 38.

By utilizing different compositions for the metal catalyst 32, and by controlling process parameters, the process can be used to produce the carbon nanoproduct 38 with desired characteristics (e.g., nanotubes, nanofibers). During continuous production of the carbon nanoproduct 38, the amount of hydrogen in a methane/natural gas hydrocarbon feed stock gas 14 remains at a constant 65-70% by volume, depending on the material being produced. When using higher hydrocarbon feedstock gas 14 such as ethylene or propane, more carbon production can be expected with less hydrogen in the product gas 34.

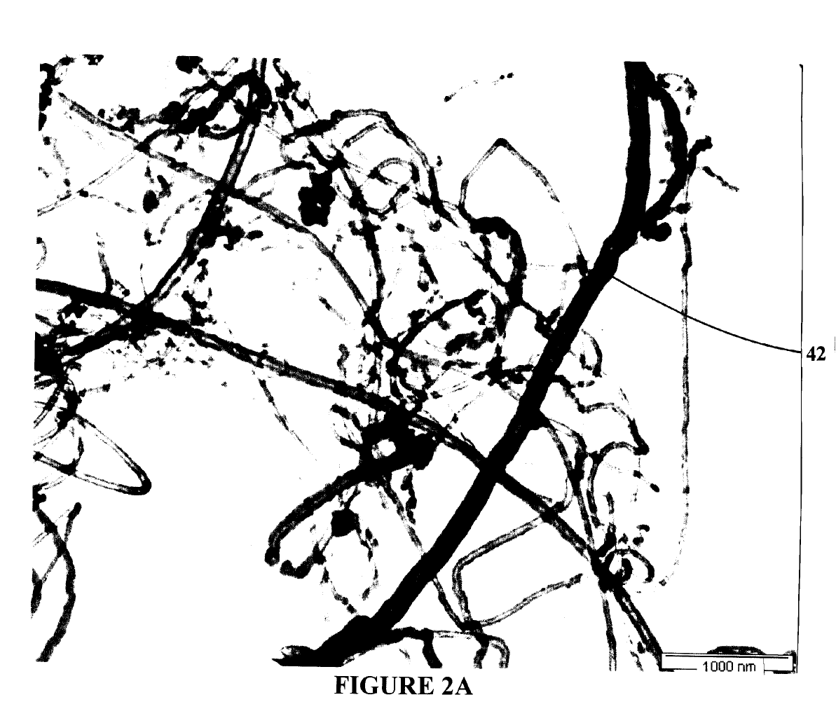

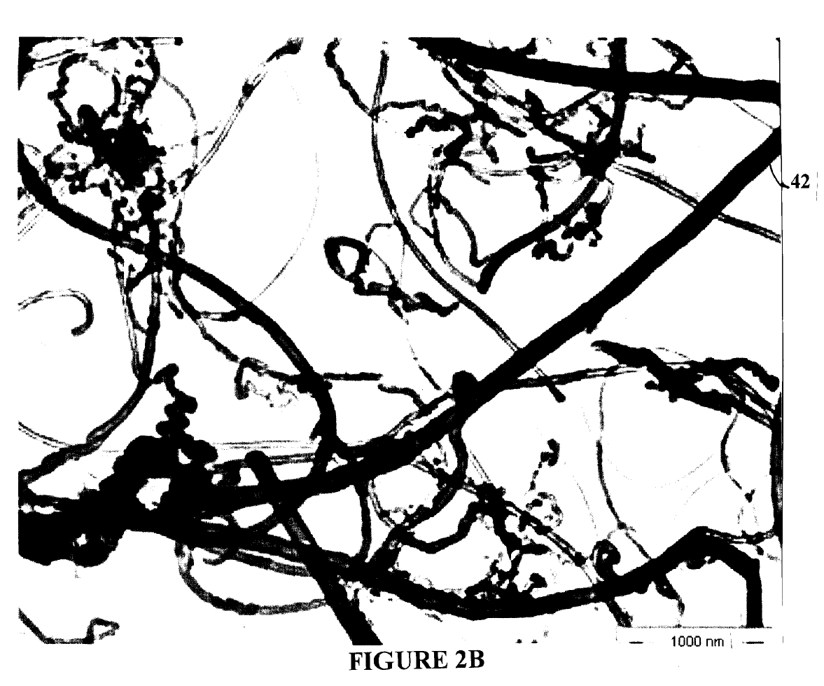

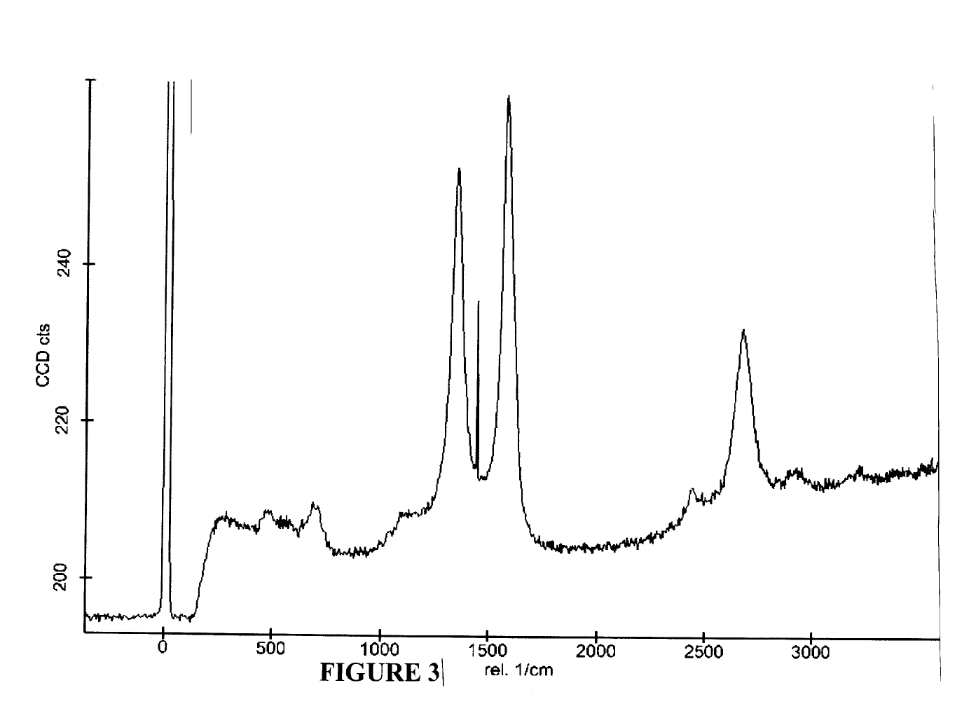

FIGS. 2A, 2B and 3 illustrate a carbon nanoproduct 38 in the form of carbon nanotubes 42. For obtaining carbon nanotubes 42 the process was controlled to provide approximately from about 20:1 to 40:1 carbon to catalyst mass ratio. As shown in FIGS. 2A and 2B, the carbon nanotubes 42 comprise randomly spaced multiwall nanotubes having diameters of from 15-30 nm and a high length to diameter ratio. The carbon nanotubes 42 also have a high purity and a length suitable for industrial applications. These characteristics are an unexpected result indicative of the unobviousness of the process.

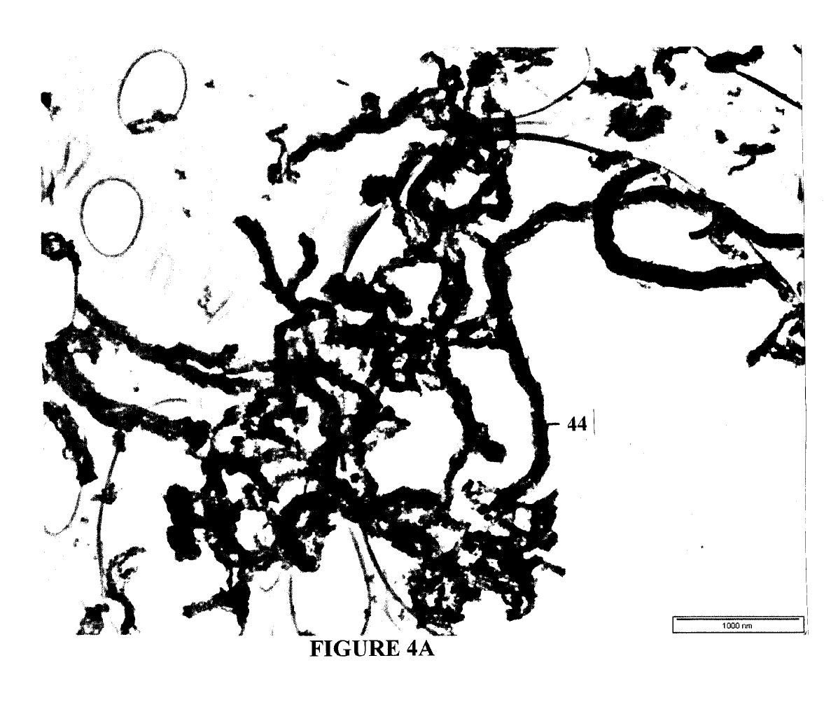

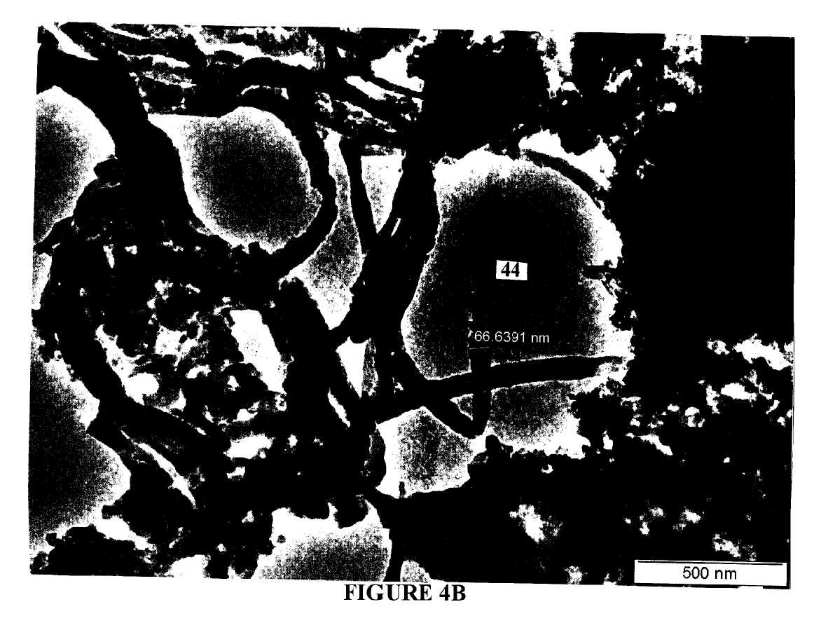

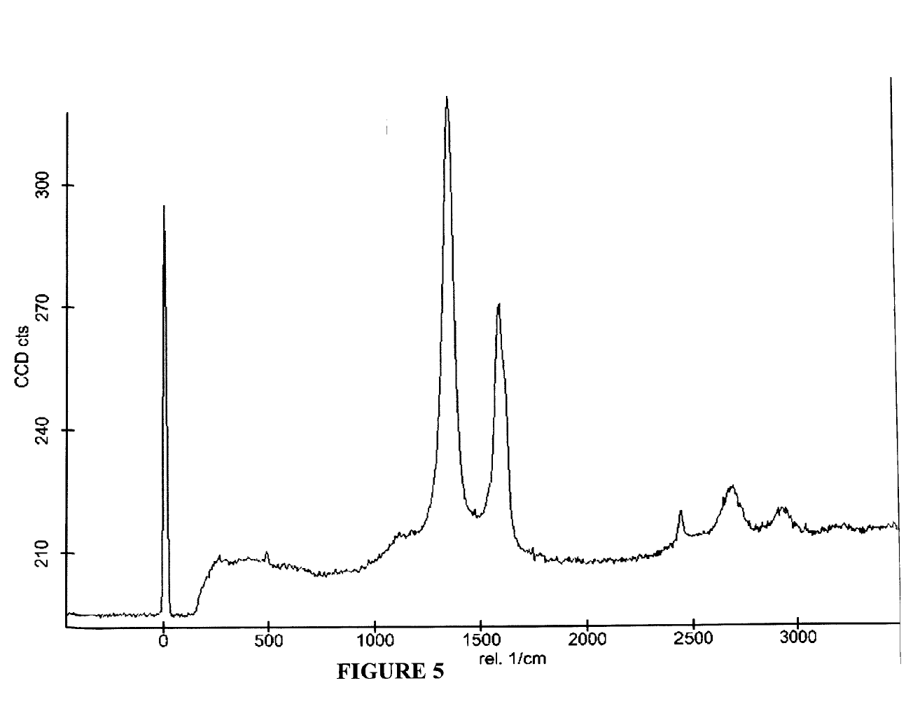

FIGS. 4A, 4B and 5 illustrate a carbon nanoproduct 38 in the form of carbon nanofibers 44. For obtaining carbon nanofibers 44 the process was controlled to provide from about 200:1 to 500:1 carbon to catalyst mass ratio. As shown in FIGS. 4A and 4B, the carbon nanofibers 44 comprise randomly spaced multiwall nanofibers having diameters of from 20-60 nm. The carbon nanofibers 44 also have a high purity and a length suitable for industrial applications. These characteristics are an unexpected result indicative of the unobviousness of the process.

While a number of exemplary aspects and embodiments have been discussed above, those of skill in the art will recognize certain modifications, permutations, additions and subcombinations thereof. It is therefore intended that the following appended claims and claims hereafter introduced are interpreted to include all such modifications, permutations, additions and sub-combinations as are within their true spirit and scope.

What is claimed is:

1. A system for producing hydrogen and a carbon nanoproduct comprising:
a hydrocarbon feed gas supply configured to supply a hydrocarbon feed gas at a selected flow rate;
a reactor comprising a hollow reactor cylinder having an enclosed inlet adapted to continuously receive the hydrocarbon feed gas, a reaction chamber in fluid communication with the inlet, and an enclosed outlet in fluid communication with the reaction chamber adapted to discharge a product gas comprised of hydrogen and unreacted hydrocarbon feed gas, along with the carbon nanoproduct;
a catalyst transport system configured to move a metal catalyst through the reaction chamber in contact with the hydrocarbon gas to form the product gas and the carbon nanoproduct, the catalyst transport system configured to provide a selected amount of catalyst in the reaction chamber dependant on the flow rate of the hydrocarbon feed gas and a selected mass ratio of the catalyst to the hydrogen feed gas; and
a carbon separator adapted to separate the carbon nanoproduct from the product gas and from the metal catalyst.

2. The system of claim 1 wherein the flow rate is between 0.05 and 3.0 liters/minute and the selected amount of the catalyst is one gram/minute.

3. The system of claim 1 further comprising a container in flow communication with the carbon separator adapted to collect the carbon nanoproduct.

4. The system of claim 1 wherein the catalyst transport system comprises a chain conveyor system, a rotating auger system, a high velocity pneumatic system or a plunger system.

5. The system of claim 1 wherein the reactor comprises a tube furnace heated by combustion or electricity to a temperature of from 600 to 900° C.

6. The system of claim 1 wherein the hydrocarbon feed gas comprises methane, natural gas or a mixture thereof.

7. The system of claim 1 wherein the mass ratio is from 20:1 to 40:1 carbon to catalyst, and the carbon nanoproduct comprises carbon nanotubes.

8. The system of claim 1 wherein the mass ratio is from 200:1 to 500:1 carbon to catalyst, and the carbon nanoproduct comprises carbon nanofibers.

9. The system of claim 1 wherein the product gas comprises 20% to 30% hydrogen by volume and 70% to 80% methane by volume.

10. A process for producing hydrogen and a carbon nanoproduct comprising:
providing a reactor having a reaction chamber in fluid communication with a hydrocarbon feed gas supply configured to provide a hydrocarbon feed gas at a selected flow rate;
providing a catalyst transport system adapted to move a metal catalyst through the reaction chamber in contact with a hydrocarbon feed gas and to provide a selected amount of the catalyst dependant on the flow rate of the hydrocarbon feed gas;
moving the hydrocarbon feed gas and the metal catalyst through the reaction chamber;
using the catalyst transport system to provide a selected mass ratio of the catalyst to the hydrogen feed gas;
heating the hydrocarbon feed gas and the metal catalyst moving through the reaction chamber;
reacting the hydrocarbon feed gas in the reaction chamber to form a product gas comprised of hydrogen and unreacted hydrocarbon gas and the carbon nanoproduct; and
separating the carbon nanoproduct from the product gas and the metal catalyst.

11. The process of claim 10 further comprising processing the product gas into pure hydrogen.

12. The process of claim 10 further comprising using the product gas as an alternative fuel comprised of 20% to 30% hydrogen by volume and 70% to 80% methane by volume.

13. The process of claim 10 wherein the heating step is performed at a temperature of from about 600 to 900° C.

14. The process of claim 10 wherein the mass ratio is from 20:1 to 40:1 carbon to catalyst, and the carbon nanoproduct comprises carbon nanotubes.

15. The process of claim 10 wherein the mass ratio is from 200:1 to 500:1 carbon to catalyst, and the carbon nanoproduct comprises carbon nanofibers.

16. The process of claim 10 wherein the flow rate of the hydrocarbon feed gas is between 0.05 and 3.0 liters/minute and the selected amount of the catalyst is one gram/minute.

17. The process of claim 10 further comprising using a portion of the product gas to perform the heating step.
